(19) United States
(12) Patent Application Publication
(10) Pub. No.: US 2003/0020824 A1
(43) Pub. Date: Jan. 30, 2003

(54) CAMERA APPARATUS

(76) Inventors: YUJIRO ITO, KANAGAWA (JP); ETSURO SAITO, KANAGAWA (JP)

Correspondence Address: FROMMER LAWRENCE & HAUG, 745 FIFTH AVENUE- 10TH FL., NEW YORK, NY, 10151, US

(21) Appl. No.: 09/102,734

(22) PCT Filed: Oct. 24, 1997
(86) PCT No.: PCT/JP97/03869

(30) Foreign Application Priority Data
Oct. 24, 1996 (JP) 8-281192

(51) Int. Cl. H04N 5/232

(52) U.S. Cl. 348/345; 348/240.3; 348/362

(57) ABSTRACT

A camera apparatus comprising a motor (9) and a driving circuit (10) for driving a focusing lens (2), a motor (11) and a driving circuit (12) for driving a zoom lens (3), a motor (13) and a driving circuit (14) for driving an iris (4), a CPU (16) having a memory (15), and gyroscopic sensors (20) and (21).

The memory stores in advance settings for camera work such as focus, zoom and iris values with respect to directions θ of the camera apparatus. In an image pickup operation, the camera takes images of an object based on the settings held in the memory. At camera angles other than the stored camera angles θ, the camera work settings are interpolated on the basis of the stored values and are thus varied automatically depending on the current camera angle θ. This ensures a smooth focus following action during image pickup by the camera apparatus.

### TECHNICAL FIELD

The present invention relates to a camera apparatus that enhances its ease of operation by incorporating an inexpensive function for executing a smooth focus follow-up action.

### BACKGROUND ART

A so-called shot box function is known conventionally as one of the capabilities of television cameras for studio use. The function involves storing beforehand in memory camera work parameters such as focus, zoom and iris settings (making up scene information, or optimal image pickup conditions) regarding a plurality of scenes (taken by a camera established in the same position but oriented in a plurality of directions, i.e., at different camera angles or in image pickup directions) When a user aims a camera having such a function at one of the multiple scenes previously stored, the function reproduces instantaneously the camera settings corresponding to the scene in question.

Because of its complexity of operation and its high cost, the shot box function has not been incorporated in news gathering cameras and like equipment required to operate under rapidly changing circumstances.

However, fast-evolving situations do not occur all the time for cameras to pick up; the news gathering camera is also used on less frenetic occasions such as when passers-by are being followed for image pickup.

When a passer-by is to be followed by a news gathering camera, a memory in the camera may store beforehand camera setting information about a plurality of scenes along the walking route in question. Between the scenes, the information for the camera to work on may be automatically interpolated on the basis of the stored settings. Such a scheme will allow the news gathering camera additionally to offer a focus follow-up capability whereby a focus follow-up action is carried out at lower costs and more smoothly than if focusing is performed manually.

It is therefore an object of the present invention to provide a camera apparatus comprising an inexpensive, smooth-to-operate focus follow-up function to improve the convenience of camera usage.

### DISCLOSURE OF INVENTION

In carrying out the invention and according to one aspect thereof, there is provided a camera apparatus having image pickup means for taking images of an object and driving means for driving the image pickup means based on predetermined settings, comprising: detecting means for detecting directions of the camera apparatus with respect to a plurality of scenes; setting means for establishing settings of the image pickup means with respect to the directions of the camera apparatus; storing means for storing the settings of the image pickup means with respect to the directions of the camera apparatus; follow-up instructing means for issuing follow-up instructions during image pickup by the camera apparatus; and controlling means acting when the follow-up instructing means issues a follow-up instruction, the controlling means whereupon varying the settings of the image pickup means based both on outputs from the detecting means and on the settings stored in the storing means with respect to the directions of the camera apparatus, the controlling means further issuing a driving instruction to the driving means in accordance with the varied settings.

With the camera apparatus of the above constitution, its memory stores in advance such camera work parameters as focus, zoom and iris settings with respect to predetermined camera directions, i.e., at camera angles θ. During image pickup, the camera apparatus takes images of the object based on the camera settings in the memory. At camera angles other than the stored angles θ, the camera work parameters for the camera to work on are interpolated from the settings at the angles θ. That is, the camera settings are varied automatically depending on the current camera angle θ. This makes it possible for the camera to execute a smooth focus follow-up operation when the camera angle is changed continuously to follow a moving object.

### BRIEF DESCRIPTION OF DRAWINGS

FIG. 1 is a block circuit diagram showing major components of a camera apparatus embodying the invention;

FIG. 2 is an explanatory view depicting how the embodiment works; and

FIG. 3 is a flowchart of steps constituting a typical control flow of the embodiment.

### BEST MODE FOR CARRYING OUT THE INVENTION

The best mode for carrying out the invention will now be described in detail with reference to the accompanying drawings.

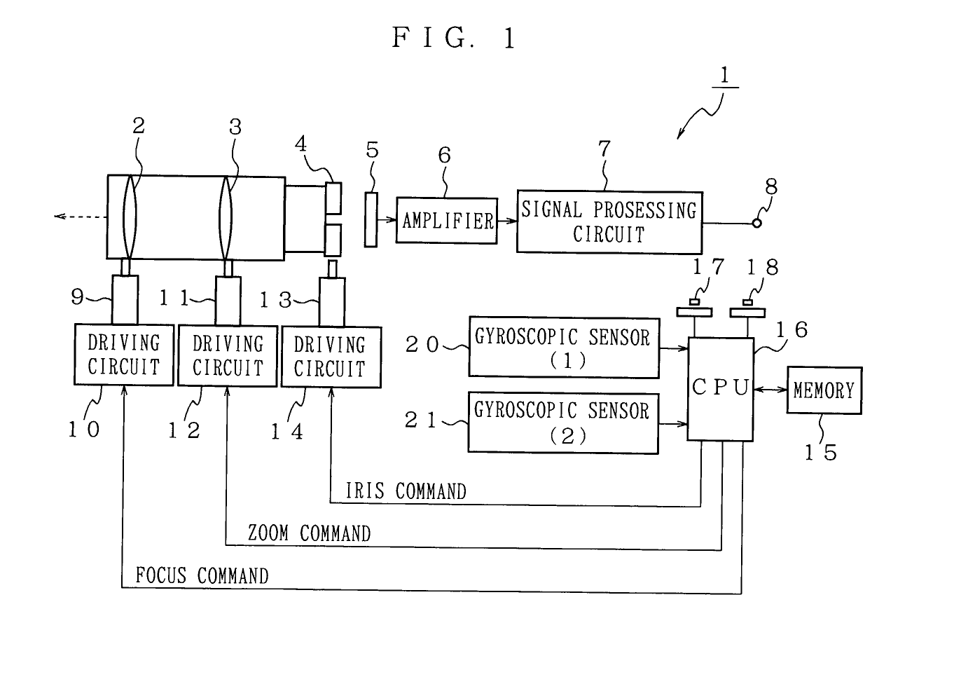

First to be described with reference to FIG. 1 is a typical constitution of a camera apparatus 1 embodying the invention. FIG. 1 is a block circuit diagram showing major components of the camera apparatus 1.

As shown in FIG. 1, the camera apparatus 1 includes an image pickup system for taking images of an object. The image pickup system comprises optics made of a focusing lens 2, a zoom lens 3 and an iris 4; a CCD (charge-coupled device) 5, an amplifier 6 downstream of the CCD 5, a signal processing circuit 7, and an output unit 8 for outputting an image signal.

The camera apparatus 1 further comprises a control system for controlling the optics. In FIG. 1, the control system is constituted by a motor 9 and its driving circuit 10 connected to the focusing lens 2, a motor 11 and its driving circuit 12 connected to the zoom lens 3, and a motor 13 and its driving circuit 14 connected to the iris 4.

As some of its novel features, the camera apparatus 1 has a CPU 16 including a memory 15, and gyroscopic sensors 20 and 21 illustratively made of angular velocity sensors to detect angles θ and movements (i.e., angular velocity) of the camera apparatus 1.

With this embodiment, the memory 15 stores beforehand information such as focus, zoom and iris set values as well as camera angles θ with respect to each of at least two scenes (i.e., the information represents camera settings that are optimal for each angle θ). The CPU 16 is connected to two switches: a setting switch 17 for timing the storage of the information into the memory 15, and a follow-up switch 18 for designating a follow-up image pickup operation, to be described later. The two switches 17 and 18 maybe implemented as a single switch capable of executing toggle and double click actions.

The motors 9, 11 and 13 indicated above are a stepping motor each. The number of pulses output to each of the motors 9, 11 and 13 is counted. The pulse counts make it possible to grasp not only the focusing value (depth of focus) of the focusing lens 2 but also the zoom set value (zoom amount) of the zoom lens 3 and iris value (iris setting) of the iris 4.

Alternatively, the stepping motors may be replaced by ordinary DC motors or by linear motors. In such cases, it is necessary to install position sensors (e.g., potentiometers) to determine the positions of the focusing lens 2, zoom lens 3 and iris 4.

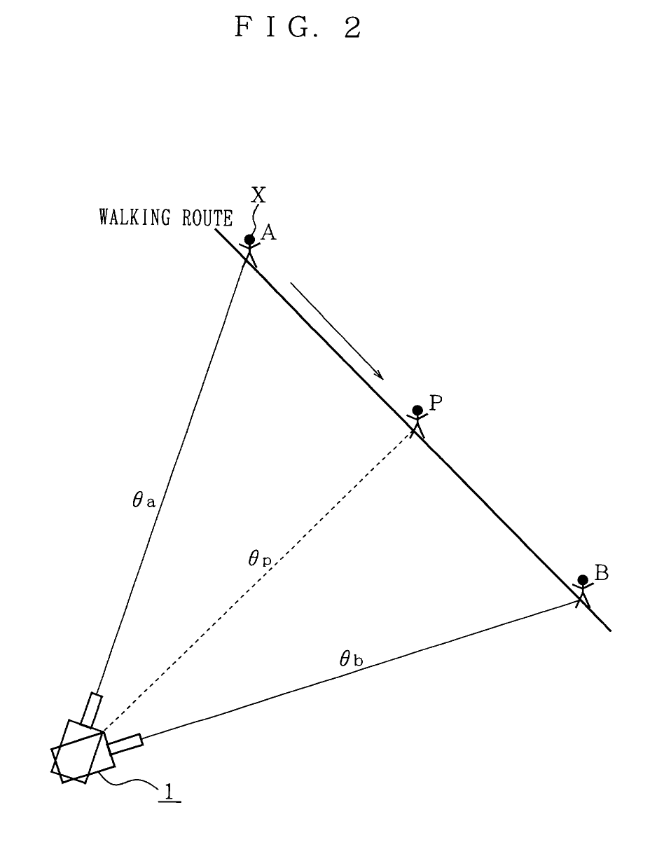

Internal processing of the camera apparatus 1 and its operation will now be described with reference to FIGS. 1 and 2. FIG. 2 is an explanatory view depicting how the camera apparatus 1 works. For purpose of simplification and illustration, it is assumed that an object X moving along a straight walking route from point A to P to B is followed by the camera apparatus 1 for image pickup.

In FIG. 1, an image of the object is input through the focusing lens 2, zoom lens 3 and iris 4 and captured by the CCD 5 (solid-state image sensing device). An image signal from the CCD 5 is amplified by the amplifier 6 before being subjected to suitable camera signal processing by the signal processing circuit 7. Past the circuit 7, the processed signal is output as an image signal from the output unit 8. If the camera apparatus 1 is equipped with a VTR (video tape recorder), the signal is sent to a VTR block located downstream (not shown).

The CPU 16 of the camera apparatus 1 according to the invention works as follows: based on the previously stored camera settings in the memory 15, the CPU 16 outputs a focus command, a zoom command and an iris command to control respectively the driving circuit 10 for the focusing lens 2, driving circuit 12 for the zoom lens 3, and driving circuit 14 for the iris 4.

The workings of the camera apparatus 1 having the above-described processing capability are described below with reference to FIG. 2. The camera apparatus 1 is assumed to take images of a moving object while being fixed at the same location (i.e., fixed-point image pickup). The object X is first placed in one of two previously selected camera angle positions (here, point A out of A and B in FIG. 2). With the camera apparatus 1 pointed toward the object X, the focusing value, zoom value and iris value of the camera are set (i.e., adjusted) so that the camera may take images of the object X under optimal conditions at the point A. The camera settings thus obtained are stored into the memory 15. The storage is effected by pressing the setting switch 17 (see FIG. 1). A camera angle θa in effect at this point is also calculated by use of the gyroscopic sensors 20 and 21 and stored simultaneously into the memory 15.

Where the gyroscopic sensors 20 and 21 are used, the camera angle θa is not output directly. Instead, the outputs of the gyroscopic sensors 20 and 21 are integrated over time for camera angle computation.

The object X is then moved to another camera angle position (e.g., point B). With the camera apparatus 1 pointed toward the object X at the point B, the focusing value, zoom value and iris value of the camera are set (adjusted) so that the camera may optimally take images of the object X. The optimal camera settings at the point B are stored into the memory 15, along with a camera angle θb in effect, by pressing the setting switch 17.

After storage of the settings, the user pushes the follow-up switch 18 to designate a follow-up operation on the object X. This causes the CPU 16 in the camera apparatus 1 to calculate continuously the focus, zoom and iris values with respect to the current angle θ on the basis of the camera settings stored in the memory 15.

Suppose that Fa, Za and Ia represent respectively the focus, zoom and iris settings (i.e., stored values) at the point A; that Fb, Zb and Ib denote respectively the focus, zoom and iris settings at the point B; and that θa and θb stand for the angles of the camera apparatus respectively at the points A and B for which images are taken from a fixed point. In that case, with the camera angle shifted from the point A to a point P (angle θp), the CPU calculates the focus, zoom and iris settings as follows:

Fp=Fa+{(θp−θa)/(θb−θa)}·(Fb−Fa) (1)

Zp=Za+{(θp−θa)/(θb−θa)}·(Zb−Za) (2)

Ip=Ia+{(θp−θa)/(θb−θa)}·(Ib−Ia) (3)

If a curve connects the points A and B, the curve may be approximated by a series of straight lines represented by a large number of points at which to acquire camera settings (e.g., points C, D, etc.). In this case, the settings for the stretches between the adjacent points may be calculated by use of the formulas above.

An application of this invention may involve having the camera apparatus 1 capture images of an important person whose passage is expected along a walking route ranging from a point A to a point B. In such a case, the focus, zoom and iris settings at the points A and B are adjusted and stored beforehand into the memory 15. At the time of subsequent image pickup, the user simply issues a follow-up instruction to get images of the person taken automatically through smooth focusing.

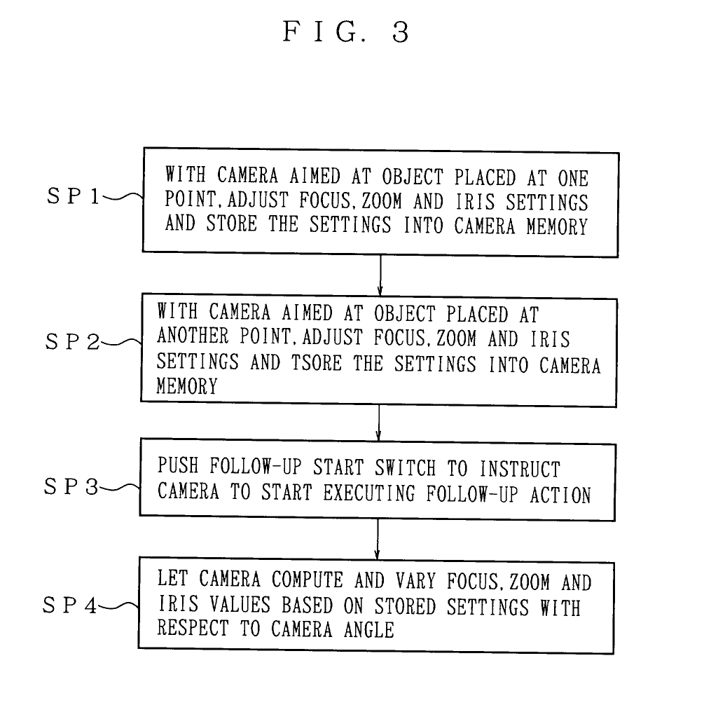

A typical control flow of the focus follow-up function according to the invention will now be described with reference to the flowchart of FIG. 3.

The user first selects the focus follow-up function of the camera apparatus 1 and starts an image pickup operation. With the camera apparatus 1 pointed toward the object X placed at one target point, the focus, zoom and iris settings are adjusted and established by pushing the setting switch 17. The switch action stores the acquired settings into the memory 15 (step SP1).

With the camera apparatus 1 pointed toward the object X placed at another target point, the focus, zoom and iris settings are also adjusted and established by pushing the setting switch 17. This causes the settings to be stored into the memory 15 (step SP2).

The user pushes the follow-up switch 18 to instruct the camera apparatus 1 to start executing a follow-up action (step SP3). On the basis of the settings held in the memory 15, the camera apparatus 1 calculates continuously the focusing, zoom and iris values at the current camera angle θ so as to vary the ongoing camera settings (step SP4).

The focus follow-up function of the camera apparatus according to the invention offers the following specific benefits:

First, when the camera apparatus 1 is shifted from one scene to another, the focus, zoom and iris settings of the camera are changed smoothly, so that images with smooth scene changes will be obtained.

Second, where scene information such as focus, zoom and iris settings of the camera apparatus 1 is stored beforehand in the memory 15 with respect to camera angles θ for an expected route of a moving object X (person, vehicle, etc.), the camera executes a smooth focus follow-up action during actual image pickup.

As described and according to the invention, continuous image pickup from one position to another is carried out under optimal imaging conditions. Optimal camera settings (camera angles θ as well as focus, zoom and iris settings in camera angles θa, θb) are obtained beforehand at a first imaging point (scene at camera angle θa in FIG. 2) and at a second imaging point (scene at camera angle θb) with respect to the angles specific to the points. The acquired settings are input to the memory and stored therein. During actual image pickup, the camera settings at the current angle θ between the target imaging points are interpolated on the basis of the previously obtained settings. This allows an automatic focus follow-up operation for optimal image pickup to be carried out more smoothly than if the focusing is performed manually.

Although the description above contains many specificities, these should not be construed as limiting the scope of the invention but as merely providing illustrations of the presently preferred embodiment of this invention. It is to be understood that changes and variations may be made without departing from the spirit or scope of the claims that follow. For example, although the above embodiment uses gyroscopic sensors 20 and 21 to detect the orientation of the camera apparatus 1, this is not limitative of the invention. Alternatively, bearing sensors based on bearing compasses or tilt sensors may be used to detect directly the angle θ of the camera apparatus.

Whereas the embodiment above is pointed toward two target points at which to acquire camera settings, more target points may be provided. With respect to the additional target points, the focus, zoom and iris settings may be calculated by use of such interpolating means as spline curves.

Furthermore, the focus, zoom and iris settings may be supplemented by such information as white balance, detail data (gradations of emphasis on image details) and flare setting (image pedestal level, i.e., black level). The supplementary information may also be stored in the memory 15 and used by the camera apparatus 1 as a basis for automatic focusing regarding the current camera angle θ.

### INDUSTRIAL APPLICABILITY

As described, the camera apparatus according to the invention may be adapted advantageously for use as a camera of an ENG (electronic news gathering) system.

1. A camera apparatus having image pickup means for taking images of an object and driving means for driving said image pickup means based on predetermined settings, comprising:
detecting means for detecting directions of said camera apparatus with respect to a plurality of scenes;
setting means for establishing settings of said image pickup means with respect to said directions of said camera apparatus;
storing means for storing the settings of said image pickup means with respect to said directions of said camera apparatus;
follow-up instructing means for issuing follow-up instructions during image pickup by said camera apparatus; and
controlling means acting when said follow-up instructing means issues a follow-up instruction, said controlling means whereupon varying the settings of said image pickup means based both on outputs from said detecting means and on the settings stored in said storing means with respect to said directions of said camera apparatus, said controlling means further issuing a driving instruction to said driving means in accordance with the varied settings.

2. A camera apparatus according to claim 1, wherein the settings of said image pickup means pertain to at least one of focus, zoom, iris, white balance, detail, and flare settings.

3. A camera apparatus according to claim 1, wherein said controlling means updates the settings of said image pickup means as needed depending on the settings stored in said storing means with respect to said directions of said camera apparatus, said controlling means further issuing a driving instruction to said driving means in accordance with the updated settings.

4. A camera apparatus according to claim 1, wherein the settings of said image pickup means are stored into said storing means the moment they are established by said setting means.

5. A camera apparatus according to claim 1, wherein said detecting means is at least one of a gyroscopic sensor, a bearing sensor based on a bearing compass, and a tilt sensor.

6. A camera apparatus according to any one of claims 1 through 5, wherein said camera apparatus is a news gathering camera.
